(19) United States
(12) Patent Application Publication
(10) Pub. No.: US 2005/0008418 A1
(43) Pub. Date: Jan. 13, 2005

(54) ADAPTABLE KEYBOARD SYSTEM

(76) Inventor: John B. Green, Santa Ana, CA (US)

Correspondence Address: JOHN B. GREEN, 1627 E. EDINGER # D, SANTA ANA, CA, 92705, US

(21) Appl. No.: 10/617,296

(22) Filed: Jul. 10, 2003

(51) Int. Cl. B41J 5/08

(52) U.S. Cl. 400/486

(57) ABSTRACT

A keyboard system primarily for hand-held computerized devices with the standard alphabet, areas of reference for ease of use, and features allowing adaptation to said devices.

References to related applications. This is a continuation of PPA application Ser. No. 00/394,483 filed on Jul. 9, 2002 entitled a Simplified Keyboard.

### FIELD OF THE INVENTION

This relates to an on screen keyboard, primarily for hand-held devices.

### BACKGROUND

### DESCRIPTION OF PRIOR ART

Every since the standard Querty keyboard was in invented to speed up typing by slowing it down to prevent jammed keys, people have yearned for a simpler format for text/data entry.

As most of these efforts have involved ten finger—two handed arrangements, it would be more pertinent to discuss the one hand typing (text/data entry) systems for Personal Digital Assistants (PDA's) hand-held computers, all phones and other devices. These are generally too small for two-handed typing and generally require a system or digit (finger or thumb(s)).

The current recommended typing system for most stylus type formats is the difficult handwriting recognition systems. This is not always accurate, is slow and cumbersome to use, and requires much proficiency.

Attempts have been made to simplify and speed up typing by several means, generally concerning; synchronous, double tapping for the next letter; scientific, placing the letters by frequency of use to minimize hand-stylus travel; deleting, limiting punctuation or leaving out numerals or functions; and downsizing, cramming the existing two-handed keyboards into a limited space or productive, a program guessing what you want. Most of these have convoluted arrangements or limited functions or both and can require switching screens or learning an entirely different format. The present circumstances of innovation; wireless, the internet, e-mail, instant messaging, etc. requires a fully functioning, user friendly, compact keyboard for a device using stylus typing.

### SUMMARY

This is an improved typing system primarily for computerized hand-held devices using areas of reference, previous learning experience and reduced number of keys while retaining full functions.

It is adaptable to various computerized devices in that some keys may be substituted for other features or functions and may be expanded to include other features.

### OBJECTS AND ADVANTAGES

The objectives of the invention are to provide a user friendly, easy viewing, more logical, natural and intuitive typing environment. This, along with a flexible and adaptive arrangement to accommodate various users.

These adaptive features would allow a manufacturer to substitute his own functions and features on certain keys, enhancing his own device, providing a competitive advantage.

### DRAWINGS

The accompanying drawings further describe the invention.

FIG. 1 is a view of the areas of reference.

FIG. 2 is a view of the preferred (consumer) standard alphabet showing keys that may be substituted.

FIG. 3 is a view of the alternate (consumer) keyboard with a core of vowels.

FIG. 4 shows the business keyboard in the numerals area, the standard (Querty) layout, minus the @ sign, placed in the punctuation-internet area (FIG. 3).

FIG. 5 Prior Art
A copy of the Fitaly one-finer keyboard.

FIG. 6 Prior Art
A copy of Hands Off™ by sensory software.

FIG. 7 Prior Art
A copy of pedit 32 by Paul Computing.

### DESCRIPTION

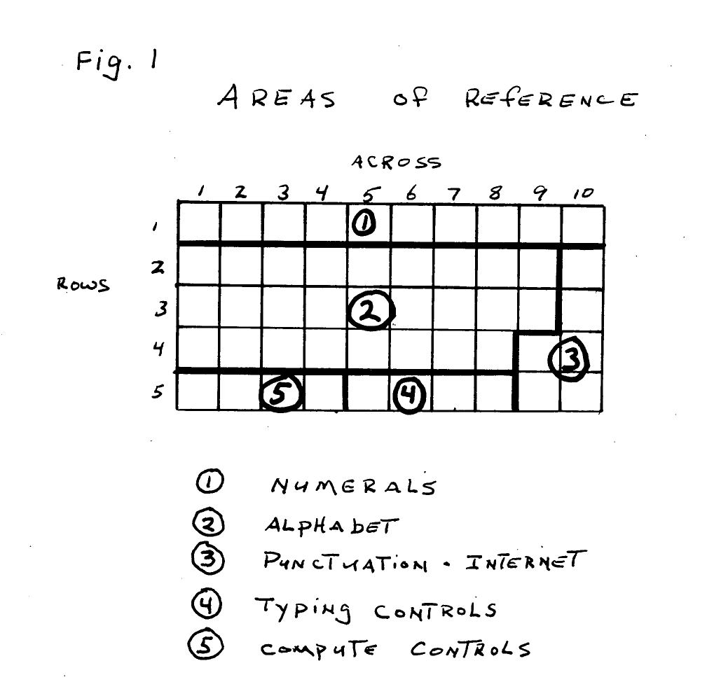

The basic invention and preferred embodiment is organized in a block of 50 (fifty) squares or keys. These are in 5 (five) rows of keys and 10 (ten), FIG. 1, across.

The block is arranged in 5 (five) areas of reference: Ref. FIG. 1.
1. Numerals: for dates, addresses, voucher numbers, times, etc.
2. The alphabet: for text entry.
3. Punctuation-Internet: for clarity of meaning and internet addresses, e-mail, etc.
4. Typing controls: following standard functions.
5. Computer controls: for navigation.

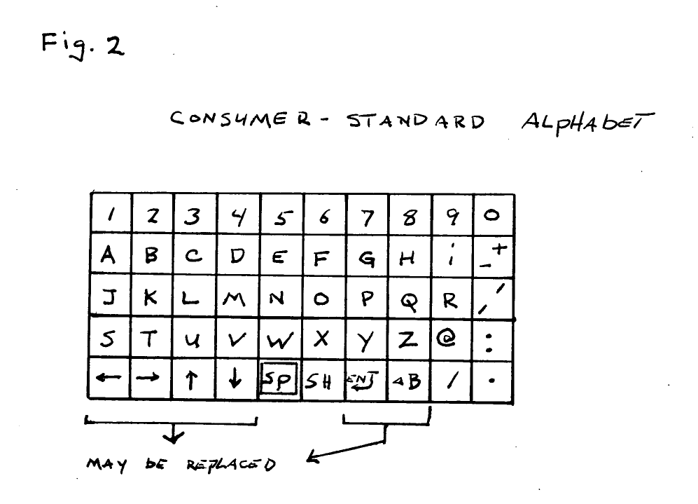

The numerals area occupies row 1, 1 through 9 across with 0 as the last key. The alphabet area occupies (Ref. FIG. 2).
Row 2, A through I (1-9 across)
Row 3, J through R (1-9) across)
Row 4, S through Z (1-8 across)

The Punctuation-Internet area occupies (Reference FIG. 2):
Row 2, key 10 across, symbol −+ (dash plus)
Row 3, key 10 across symbol ,' (comma, apostrophe)
Row 4, key 9 across symbol @ (at),
Row 4, key 10 across symbol : (colon)
Row 5, key 9 across, symbol / (slash)
Row 5, key 10 across, symbol . (period)

The computer control area occupies (Ref. FIG. 2):
Row 5, keys 1 through 4 across, symbols ←↑→↓ (conse).

The typing control area occupies:
Row 5, keys 5 through 8, symbols SP (space)
SH (shift) ENT (enter) and

<B (Back) consecutively.

Upper case symbols/letters are offset for clarity.

This arrangement has many advantages compared to most other keyboards.

The use of the standard alphabet is ubiquitous and takes advantage of previous knowledge and experience.

The areas of reference provide a lean delineation of functions and is helpful in providing a user friendly, easy viewing, logical, more natural and intuitive environment, an objective of the invention. It helps alleviate the need for the casual typist to “hunt and peck.”

The use of the 50 (fifty) block keyboard, as opposed to the standard approximately 64-69 keys, allows for larger and clearer keys and symbols/letters, versus larger keyboards in any relative space.

This provides better control with a stylus-finger and easier reading of the symbols/letters when in use.

This is done while still providing necessary functions by deleting duplicate and unnecessary keys.

As an objective of the invention is to provide a system with the flexibility to suit the user, an alternative alphabet has been provided. This is one with a core of vowels in the center, providing an area of reference in the alphabet itself. Its primary use is to help minimize hand/stylus travel, speeding typing. This would require a longer learning curve and greater proficiency.

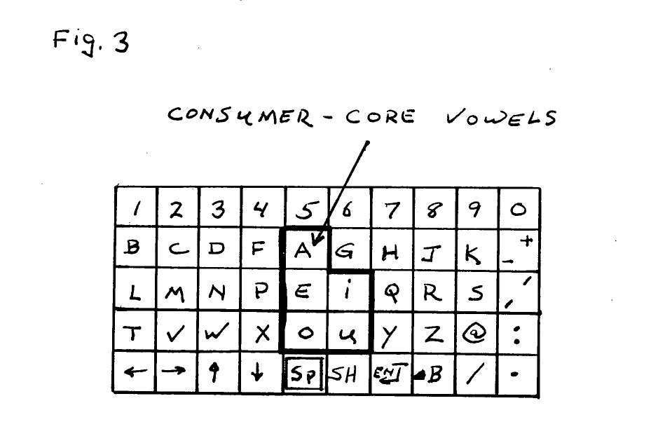

This alternative alphabet is as follows (Ref. FIG. 3):
Row 2, 1 across, B 2.C 3.D 4.F 5.A 6.G 7.H 8.J 9.K
Row 3, 1 across L 2.M 3.M 4.P 5.E 6.I 7.Q 8.R 9.S
Row 4, 1 across T 2.V 3.W 4.X 5.O 6.U 7.Y 8.Z

The standard alphabet is taken and the vowels removed. The core of vowels is in (Reference FIG. 3):
Row 2, 5 across, letter A
Row 3, 5 across, letter E, 6 across, letter I
Row 4, 5 across, letter O, 6 across, letter U

The other letters fall in place on either side of the core area according to their order with the vowels removed.

The OEM user requires flexibility so he may adapt to his own design. This is provided by the computer control area (FIG. 1.) and the enter (ENT) and back (<B) keys in the typing area. As these keys may be duplicated on their own device, they may be removed and substituted with functions/features of the OEMs own choosing to enhance the functionality of the device and his competitive advantage in the market.

As an objective of the invention is to avoid duplication of functions and provide a flexible and adaptable system, it becomes a high desirable utility feature.

FIG. 2 shows the areas involved, with a suggested replacement, in this case said PDA functions while the typing area shows possibilities of the OEM's own choosing.

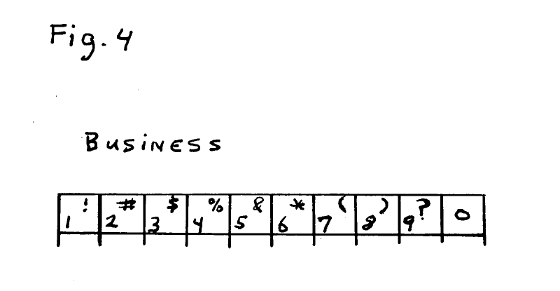

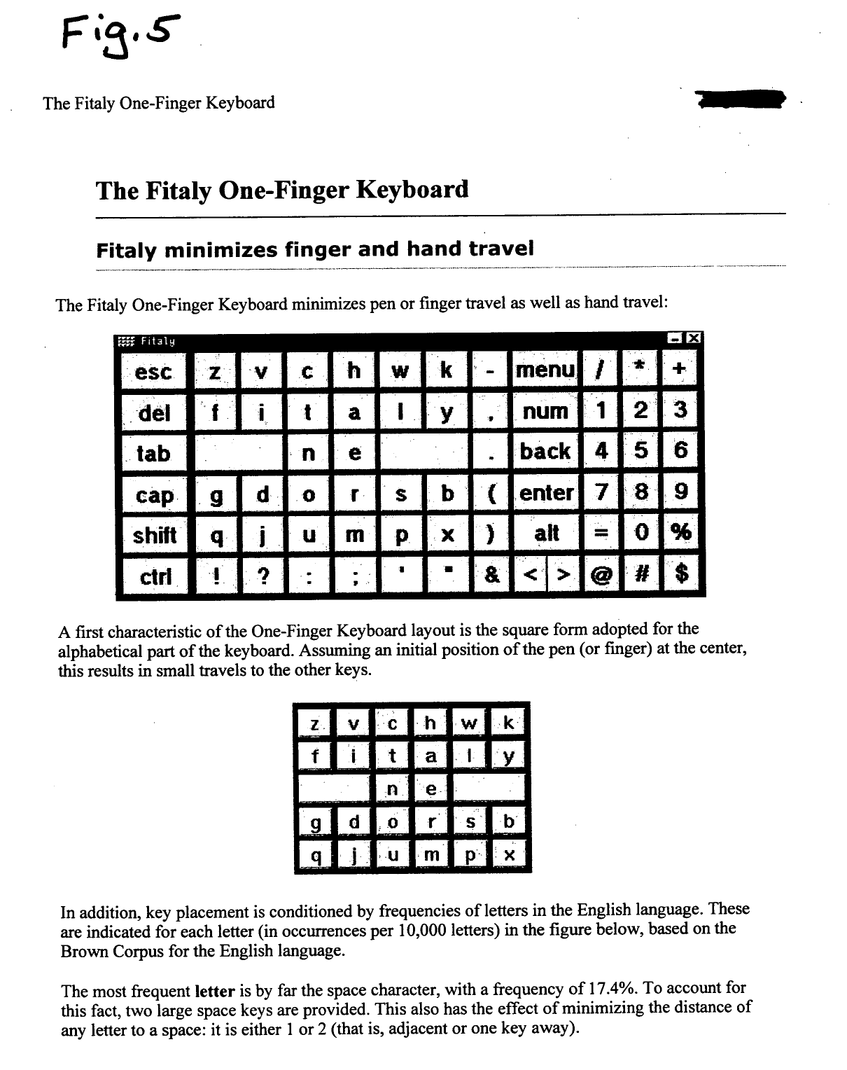

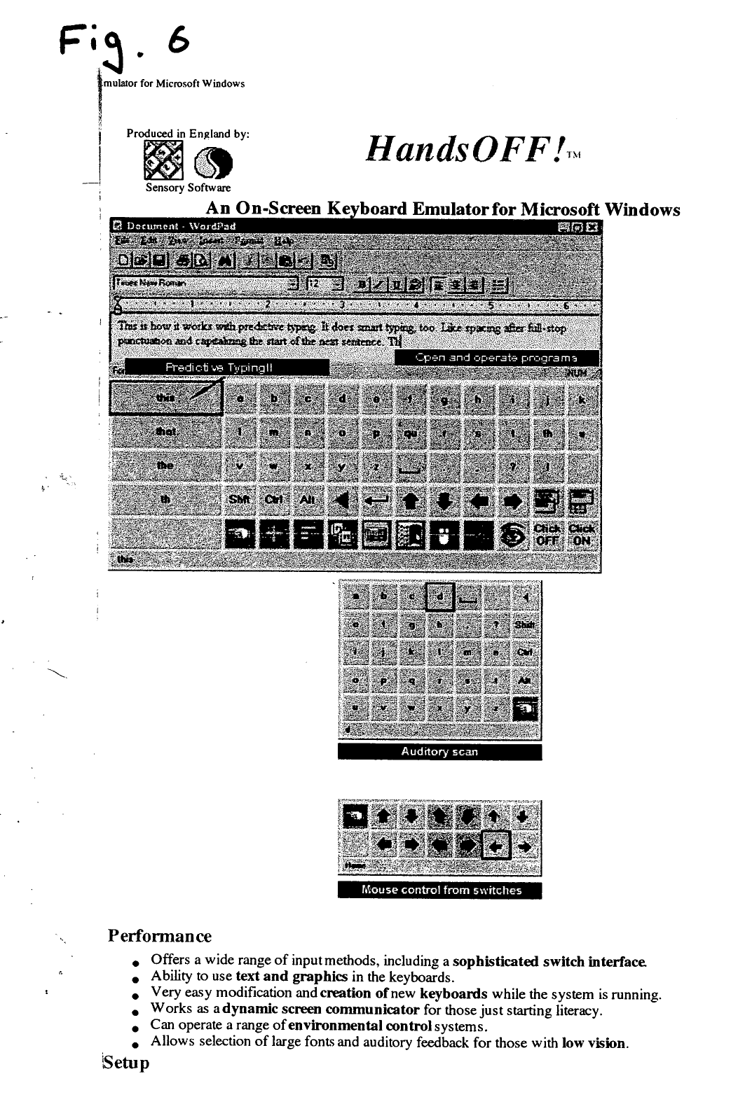

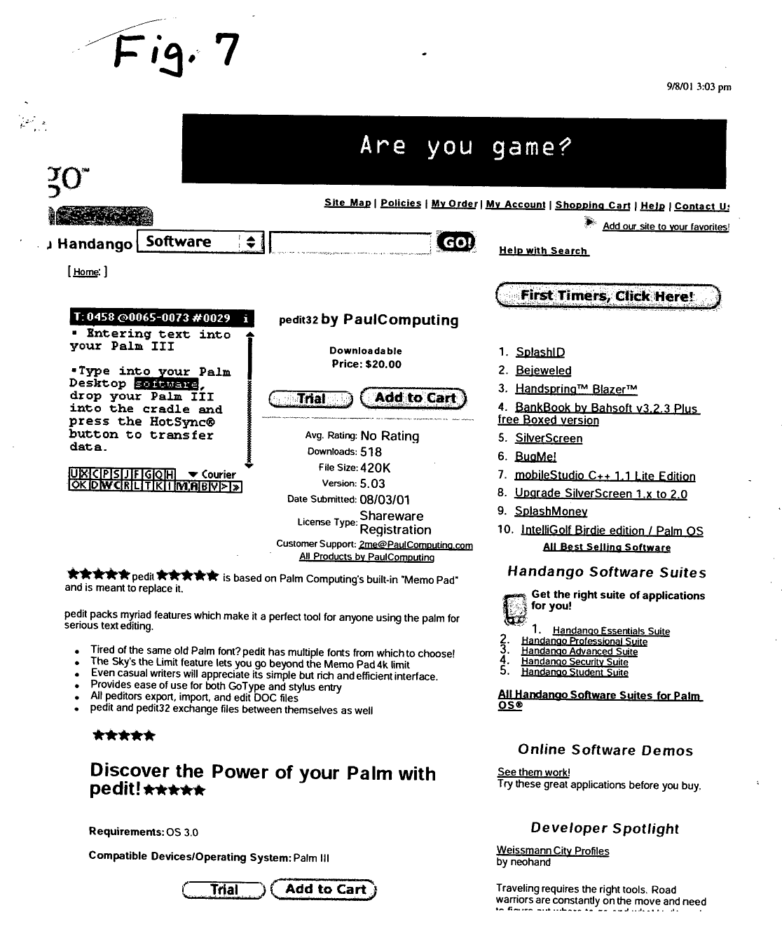

In keeping with the adaptability and utility features of the invention, the keyboard may be adapted to include symbols used on the standard keyboard, primarily for business (Ref. FIG. 4).

These are placed in the standard position on the numeral keys, offset in the right hand corner, for clarity and to signify the upper case. This will mitigate the learning curve by providing familiarity to even casual typists.

As the @ sign is used in the punctuation-internet area, it has been illuminated from the layout.

Thus, in the numeral reference area, we have the number and symbol.

| | |
|---|---|
| 1! | EXCLAMATION |
| 2# | NUMBER |
| 3$ | DOLLAR |
| 4% | PERCENT |
| 5% | AND |
| 6* | STAR |
| 7( | PARENTHESES LEFT |
| 8) | PARENTHESIS RIGHT |
| 9? | QUESTION |

The inclusion of this feature in the keyboard would enhance its value in the enterprise (business) market as opposed to the consumer market.

In keeping with the adaptability features of the invention, the numerical area of reference may be deleted for those devices that have a numeric key pad (cell phones, etc). The plus (+) sign may be deleted and replaced with a more useful or functional sign. This invention may be formed in any approximate computer language for the computerized device it is used on.

1. An English language keyboard and method and system for typing on computerized devices:
Wherein there are areas of reference comprising numerals top row in order 1-9 ending in 0; alphabet in order second third and forth row A-I, J-R, S-Z; punctuation-internet in the last column and second to last column as alphabet permits through the last row comprising −+, ', :, ., /, @; typing control area in last row comprising right to left space shift enter and back; computer controls comprising back forward up and down in the last row right to left, before typing controls.

2. The keyboard of claim 1 with features to adapt it to various computerized devices:
Wherein the enter and/or back keys of the typing area may be substituted with functions or features of the users' own choosing.
Wherein the numerals may be deleted.
Wherein the + sign may be deleted and replaced with a sign of the users own choosing.
Wherein the numerals area may be expanded to include symbols and functions found on the standard keyboard comprising !, #, $, %, *, (, ), ?, offset in the upper case.

3. The Keyboard of claim one with an alternate alphabetic layout:
Wherein the vowels are removed form their normal position and placed in the center of the alphabet area, A being below the numeral 5, E being below A and O being below E, I to the right of E and U to the right of O, the other letters falling in place on either side of this core area according to their order with the vowels removed.
